(19) United States
(12) Patent Application Publication
(10) Pub. No.: US 2007/0174879 A1
(43) Pub. Date: Jul. 26, 2007

(54) Home movie cable box

(76) Inventor: Theodoros H. Asimakopoulos, Wheaton, MD (US)

Correspondence Address: Theodoros Asimakopoulos, 3703 Jeffry St, Wheaton, MD, 20906, US

(21) Appl. No.: 11/336,159

(22) Filed: Jan. 20, 2006

(51) Int. Cl. H04N 7/173; G06F 3/00; H04N 5/445; G06F 13/00

(52) U.S. Cl. 725/87; 725/86; 725/61

(57) ABSTRACT

New service that allows individual to view new motion pictures that they Would not ordinarily be able to view unless going to the movie theater. This new service is made possible through the use of cable television.

### CROSS REFERENCE TO RELATED APPLICATIONS

Not Applicable

### FIELD OF INVENTION

This invention relates to a new process of viewing new motion pictures through cable television that you would not be able to view at home by the conventional process of going to the movie theater.

### BACKGROUND OF INVENTION

To ordinarily view new motion pictures, a person would go to a movie theater. With this new service, someone can view a movie from the comfort of his or her own home. This is possible through the use of cable television.

### SUMMARY OF THE INVENTION

New service that makes possible for an individual to view new motion pictures that they normally would not be able to view at home. This is achieved through the use cable television.

### DETAILED DESCRIPTION OF THE INVENTION

Cable that sends signal into home receiver that is connected into television. This process is cable television. Therefore through this service individual is able to view new motion pictures in the comfort of their own home.

What is claimed:

1. New service that allows individual to view new motion pictures in the comfort of their own home through the use of cable television. Public can only access new motion pictures by going to the movie theater. It takes four months after new motion picture is introduced to public for movie to become available on dvd. Through new service that involves using cable television to access service.
